(19) United States
(12) Patent Application Publication
(10) Pub. No.: US 2007/0093987 A1
(43) Pub. Date: Apr. 26, 2007

(54) Knowledge generation support system, parameter search method and program product

(75) Inventor: Toyoo Iida, Nagaokakyo-Shi (JP)

Correspondence Address: OSHA LIANG L.L.P., 1221 MCKINNEY STREET, SUITE 2800, HOUSTON, TX, 77010, US

(73) Assignee: OMRON Corporation, Kyoto (JP)

(21) Appl. No.: 11/245,592

(22) Filed: Oct. 7, 2005

(51) Int. Cl. G06F 15/18; G06F 11/30

(52) U.S. Cl. 702/183; 706/13

(57) ABSTRACT

A system is disclosed which can easily search and determine the effective feature amount suitable for determining the normality/abnormality of an object to be inspected in an inspection/diagnosis apparatus and the various parameters for calculating the effective feature amount. A parameter search unit searches for the various parameters used for calculating the feature amount. A feature amount calculation unit calculates a plurality of feature amounts based on the various parameters searched by the parameter search unit from a given sample data including the normal and abnormal data. An assessment unit outputs the excellence of the various parameters as an assessment value from the result of calculation of the feature amount determined by the feature amount calculation unit. The parameter search unit searches the various parameters again based on the assessment result of the assessment unit thereby to determine an effective feature amount a high assessment value and the various parameters for the particular effective feature amount at the same time.

### BACKGROUND OF THE INVENTION

1. Field of the Invention

This invention relates to a knowledge generation support system, a parameter search method and a program product.

2. Description of the Related Art

A great number of rotary machines with a built-in motor are used for automobiles and home electric appliances. In an automobile, for example, rotary machines are mounted in a great number of parts including an engine, a power steering system, a power seat and a transmission. The home electric appliances, on the other hand, include various products such as a refrigerator, an air-conditioner and a washing machine. Once these rotary machines are started, a sound is generated with the rotation of the motor, etc.

Some of these sounds are generated as a natural result of the normal operation, and others are caused by a malfunction. Examples of the abnormal sound due to a malfunction include the trouble of a bearing, internal abnormal contact, unbalance or foreign matter. More specifically, the abnormal sound includes the sounds due to a gear cut which occurs at the rate of once every gear rotation, bite of foreign matter, spot scratch or an instantaneous rubbing between the rotary portion and the fixed portion in the motor. The noises uncomfortable to human ears are various in the audible range of 20 Hz to 20 kHz, and have the frequency of about 15 kHz, for example. An abnormal noise is generated in the case where the sound of this predetermined frequency component is involved. The abnormal sounds are of course not limited to this frequency band.

These noises due to malfunctions are not only uncomfortable but also may cause a more serious malfunction. In view of this, production factories conduct the “sensory test” normally resorting to the five senses such as the hearing sense and the tactual sense of the inspector to determine the presence or absence of an abnormal noise with the aim of quality assurance of each product. Specifically, vibrations are checked by hearing or touching. The sensory test is defined by the Sensory Test Terms JIS Z8144.

Demand for high sound quality of automobiles has sharply intensified since several years ago. Specifically, in the automobile industry, the need has heightened to quantitatively and automatically inspect the on-vehicle drive parts such as the engine, transmission and the power seat. The quality meeting these needs cannot be achieved any more by the conventional qualitative, ambiguous inspection such as the sensory test conducted by the inspector.

In order to solve this problem, a noise inspection system has been developed with the aim of a stable inspection based on a quantitative and definite standard. This noise inspection system is intended to automate the “sensory test” process and conduct the inspection in such a manner that the vibration and the sound of the drive unit of a product are measured with a sensor and the frequency component of the analog signal thereof is checked using a frequency analyzer in accordance with the FFT algorithm. As an alternative, the analog signal may be analyzed using a bandpass filter.

This technique is briefly described. The frequency analyzer based on the FFT algorithm can analyze the time domain signal in the frequency domain by the fast Fourier transform algorithm. The frequency domain of the noise is also determined to some degree. Thus, the frequency component corresponding to the noise area can be extracted from the frequency components extracted by the analysis, and the feature amount of the thus extracted frequency component is determined. From this feature amount, the presence or absence of a noise and the cause thereof are estimated by the fuzzy logic or the like.

In the noise inspection system described above, the automatic determination is possible according to an established standard on the one hand, and the inspection result (achievement) and the related waveform data can be stored in a memory in the noise inspection system at the same time.

Under the circumstances, the noise inspection system described above is so operated that the optimum feature amount and the various parameters for calculation of the feature amount are selected intuitively and empirically by a person. In the prior art, the automation of the search for the optimum parameter is proposed by, for example, “an optimization method and apparatus using the generic algorithm”. In the method and apparatus described above, the hierarchical generic algorithm and the parallel generic algorithm are considered to contribute to an improved search accuracy in the complicated optimization problem of the generic algorithm.

In the conventional noise inspection system described above, the feature amount corresponding to the presence or absence of a noise is extracted and the various parameters for calculation of the feature amount are selected by the intuition and experiences of the person.

Determining the presence or absence of an abnormality from more than several thousands data on the abnormality inspection and selecting a corresponding feature amount and parameters for calculating the feature amount requires not only the experience and intuition but also a great number of processes, thereby hampering the automatic inspection/diagnosis.

Especially in the automobile industry, the sales of new vehicles reaches a peak immediately after the release and tends to drop within several months. Therefore, a high product conformity is required from the very beginning of new model production, and it is a matter of urgency to assure sharp rise of the production quality. For this reason, the optimum parameter for the noise inspection system is required to be determined at an early time. The determination of the optimum parameter by the experience and intuition of the person, however, consumes an excessively long time.

The application of the hierarchical generic algorithm described above to specify the optimum parameter for the noise inspection system, on the other hand, poses the following problem. Specifically, the parameters (crossover value, mutation rate, selection method) for controlling the operation of the generic algorithm having no hierarchical structure are set by trials and errors. In the case where such parameters are accumulated in a hierarchy, therefore, trial and errors equivalent to manual selection of the feature amount and the operation parameters are required to acquire the desired result.

Further, the control operation of the generic algorithm is complicated, and therefore it is difficult to incorporate a search strategy corresponding to the characteristics of the various parameters (the effects between the parameters) desired to search. As a result, even in the case where the above-mentioned method is used, the optimum parameter cannot be easily acquired efficiently within a short time.

Furthermore, the data on the presence or absence of an abnormality determined by the operator to search the parameters (the teacher data for learning, or the sample data) may contain an error. The search for the parameters with such an error may fail, or require a very long time before the optimum solution is reached.

### SUMMARY OF THE INVENTION

The object of this invention is to provide a knowledge generation support system, a parameter search method and a program product in which an effective feature amount adapted for determining the normality/abnormality of an object of inspection in the inspection/diagnosis apparatus and various parameters for calculating the effective feature amount can be easily searched and determined, and in which even in the case where the sample data used for search contains some ambiguous data, the effective feature amount can be determined accurately and quickly.

According to one aspect of the invention, there is provided a knowledge generation support system for determining an effective feature amount suitable for an object of inspection in an inspection/diagnosis apparatus to determine whether the object of inspection is normal or abnormal based on the feature amount data obtained by the filtering process and the feature amount extraction process executed on the acquired measurement data on the one hand and various parameters for calculating the effective feature amount on the other hand. The system includes a search unit for searching the various parameters to calculate the feature amount, a feature amount calculation unit for calculating a plurality of feature amounts based on the various parameters obtained in the search unit from given sample data containing normal and abnormal data, and an assessment unit for outputting, as an assessment value, the excellence of the various parameters from the calculation result of the feature amount determined by the feature amount calculation unit, wherein the search unit searches the various parameters again based on the assessment result of the assessment unit thereby to determine the effective feature amount high in assessment value and the various parameters of the particular effective feature amount at the same time.

The methods of searching the various parameters in the assessment unit include:
(1) A method in which the degree of the ability to separate the normality and abnormality is emphasized.
(2) A method in which the number of the feature amounts separable is emphasized.

One of these methods is selectively executable, and in accordance with the search method thus set, one of the types described below is determined.
(1) An effective feature amount that can best separate the normality and abnormality from each other and various parameters for calculating the effective feature amount.
(2) A plurality of effective feature amounts for separating the normality and abnormality from each other and various parameters for calculating the effective feature amounts.

Further, in the knowledge generation support system according to the invention, the sample data is divided into the abnormal data and the normal data for the same abnormality type.

According to another aspect of the invention, there is provided a parameter search method for a knowledge generation support system in which based on the feature amount data acquired by subjecting the acquired measurement data to the filtering process and the feature amount extraction process, an inspection/diagnosis apparatus determines whether an object of inspection is normal or abnormal, so that the effective feature amount suitable for the object of inspection and the various parameters for calculating the effective feature amount are determined. With regard to given sample data containing the normal and abnormal data, a plurality of feature amounts are calculated based on the various parameters set by the feature amount calculation unit, and from the result of calculation of the feature amount determined by the feature amount calculation unit, the assessment value indicating the excellence of the various parameters is calculated, the various parameters are searched again based on the calculated assessment result, and the feature amount calculation and the assessment value calculation are repeated based on the various parameters searched, so that the effective feature amount high in assessment value meeting the set search finish conditions and the various parameters of the effective feature amount are determined at the same time.

In this case, two types of methods are prepared for searching the various parameters including a first method in which the degree of the ability to separate the normality and abnormality is emphasized and a second method in which the number of the feature amounts that can be separated is emphasized, and in accordance with the set search method, the first method or the second method is executed thereby to determine either
(1) an effective feature amount that can separate the normality and abnormality from each other most effectively and various parameters for calculating the effective feature amount, or
(2) a plurality of effective feature amounts for separating the normality and abnormality from each other and various parameters for calculating the effective feature amounts.

According to still another aspect of the invention, there is provided a program product for determining an effective feature amount suitable for an object of inspection in an inspection/diagnosis apparatus for determining whether the object of inspection is normal or abnormal based on the feature amount data obtained by subjecting the acquired measurement data to the filtering process and the feature amount extraction process on the one hand and various parameters for calculating the effective feature amount. The program product has a program portion for executing the steps of calculating, with regard to a given sample data containing normal and abnormal data, a plurality of feature amounts based on the various parameters set by the feature amount calculation unit, calculating an assessment value indicating the excellence of the various parameters from the result of calculation of the feature amounts determined by the feature amount calculation unit, searching the various parameters again based on the calculated assessment result, repeating the feature amount calculation and the assessment value calculation based on the various parameters searched until the search finish conditions set are satisfied, and determining the effective feature amount high in assessment value meeting the set search finish conditions and the various parameters of the effective feature amount at the same time.

Further, as a process for searching the various parameters, two methods may be employed including a first method in which the degree of the ability to separate the normality and abnormality from each other is emphasized and a second method in which the number of the feature amounts that can be separated is emphasized, and the program product may have a program portion for executing the first method or the second method in accordance with the set search method. Each aspect of the invention described is realized according to the first embodiment.

According to this invention, the selection of the feature amount in the inspection/diagnosis apparatus and the determination of the various parameters for feature amount calculation are automated thereby to reduce the number of search steps executed by the person.

The search unit applies the generic algorithm to the individuals with the various parameters coded, and executes the crossover, mutation and selection operation until the desired conditions are met thereby to search for the optimum parameters. The genes in the individuals thus coded are divided into blocks by function, so that the manifestation or concealment of the character of the genes may be controlled by block. This aspect of the invention is implemented by the second embodiment.

The GA operation parameter more perspective than the hierarchical generic algorithm (GA) can be set. Also, the genes are divided into blocks by function and the generic operation performed by block. Therefore, the search strategy based on the effects between the parameters desired for search can be easily formed.

Further, the invention may have the function in which whenever the desired conditions are met by the search based on the various parameters using all the sample data, the data estimated as an erroneous determination is extracted from the sample data, and in the case where the assessment value obtained when determining the various parameters using the sample reconstructed regarding the particular data as an erroneous determination is higher than the assessment value before the reconstruction, then the data estimated as an erroneous determination is finally judged as data of an erroneous determination. This judgment is performed by the erroneous determination data detector 18 according to this embodiment. The data judged as an erroneous determination is more preferably output to a display unit and other output means to permit the user to confirm the contents thereof.

The reconstruction described above may include the execution of at least one of the process for deleting the data estimated as an erroneous determination, the process for changing to a sample group of the reverse determination result and the process of changing the sample group of a different determination result. Further, the data finally judged as an erroneous determination is updated to the correct sample data, while executing the search by the search unit. According to this embodiment, the update operation is performed by the erroneous determination data filter 19.

According to this invention, an error, if contained in the sample data prepared by a person to determine the inspection/diagnosis conditions, can be deleted as an error candidate or incorporated into the reverse determination, and therefore the search failure or the protracted search based on the data error can be prevented. Also, by presenting the error candidate to the user, the user determination can be verified. Specifically, the “effective feature amount” and the “various parameters for calculating the effective feature amount” can be easily and quickly determined at the same time from the conformity/nonconformity decision data (sample data) prepared by a person containing the ambiguity.

The “inspection/diagnosis apparatus” is a noise inspection system (apparatus) according to this embodiment, to which the invention is not limited, and any inspection/diagnosis apparatus for vibrations or other waveform signals are equally applicable. Further, regardless of the waveform signals, the invention is applicable to various equipment maintenance/inspection systems and the parameters for the related measurement methods can be determined.

### BRIEF DESCRIPTION OF THE DRAWINGS

FIG. 1 shows a block diagram of a first embodiment of the invention.

FIG. 2 shows a data structure of an inspection achievement file.

FIG. 3 shows a flowchart for explaining the functions (operating principle) of the first embodiment.

FIG. 4 shows an example of coding.

FIG. 5 shows an example of the table index indicating the value of each gene for coding.

FIG. 6 shows another example of the table index indicating the value of each gene for coding.

FIG. 7A shows a diagram for explaining the crossover.

FIG. 7B shows a diagram for explaining the mutation.

FIG. 8 shows a diagram for explaining an example of the feature amount calculation in a noise inspection system.

FIG. 9 shows an example of coding used in a second embodiment of the invention.

FIG. 10 shows a diagram for explaining the blocking of the coding used in the second embodiment of the invention.

FIG. 11A shows a diagram for explaining the block-based crossover.

FIG. 11B shows a diagram for explaining the block-based mutation.

FIG. 12 shows a block diagram illustrating the essential parts of the second embodiment of the invention.

FIG. 13 shows a flowchart for explaining the functions (operating principle) of the essential parts according to the second embodiment.

FIG. 14 shows a block diagram of a third embodiment of the invention.

FIG. 15 shows a flowchart for explaining the functions (operating principle) of the essential parts according to the third embodiment.

FIG. 16A and FIG. 16B show a diagram for explaining the operation of the third embodiment of the invention.

### DESCRIPTION OF THE PREFERRED EMBODIMENTS

Prior to the explanation of each embodiment, a noise inspection system (waveform inspection system) for which the feature amount and the parameters are set according to this embodiment is briefly explained. This noise inspection system has such a basic configuration that the waveform data acquired by a vibration sensor or a microphone is preprocessed by a filter, after which a plurality of predetermined feature amounts are extracted, and using the effective ones of the extracted feature amounts, the overall feature amount is determined so that a conforming product, a nonconforming product or indefinitive product is determined. Several types of filters including the bandpass filter, the low-pass filter and the high-pass filter are prepared. Also, a multiplicity of feature amounts (say, 40 types) to be extracted are prepared. The preprocessing and the feature amounts effective for the conformity/nonconformity decision of an object of inspection are predetermined. In the case where the feature amounts not very effective are predetermined, therefore, the process for determining the features amounts not very effective is wasteful. In view of this, according to this invention, a feature amount suitable for the object of inspection is determined and set in the noise inspection system. Further, each feature amount, for which the calculation method is determined, and the feature amount value and the determination result can be changed by changing the parameters. In other words, once the parameters are erroneously set, an erroneous determination may result even with the originally effective feature amount.

In the prior art, the simple analysis of an object is conducted by a person by trials and errors based on the sample data thereby to determine a possibly effective feature amount for the conformity/nonconformity decision on the object. Further, based on thousands of sample data (including the conformity/nonconformity decision result), the person determines the effective setting conditions, by trials and errors, as to which filter should be used for preprocessing, how many parameters should be used for the particular filter, which feature amount should be used and how many parameters of the particular feature amount should be employed. As a result, the effective feature amounts are made clear. In the actual noise inspection system, therefore, the conformity/nonconformity decision can be made efficiently within a short time by setting only the effective feature amounts and the parameters.

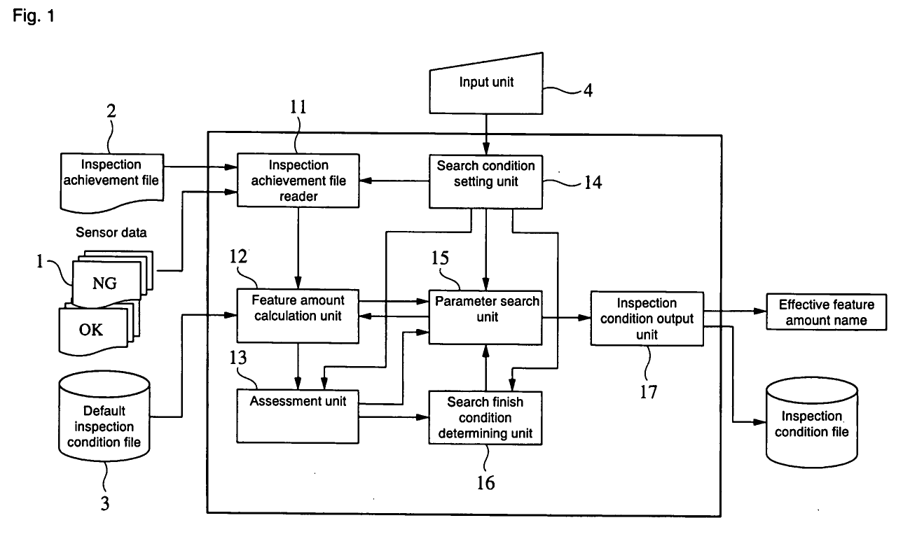

According to this invention, there is provided a system in which the effective feature amounts and the various parameters of the feature amounts can be automatically searched based on the sample data including the conformity/nonconformity decision result (which may be made by a person). FIG. 1 shows a first embodiment of the invention. As shown in FIG. 1, the input data to the system include a sensor data 1, an inspection achievement file 2, a default inspection condition file 3 and various information supplied through an input unit 4.

The sensor data 1 is acquired by sensing the vibration or sound generated in the inspection/diagnosis object. The waveform data, i.e. the measurement data of the generated sound is recorded in a file thereby to create one file for each measurement. In other words, the actual output waveform is detected using the microphone and the vibration sensor. Each file is assigned an independent file name.

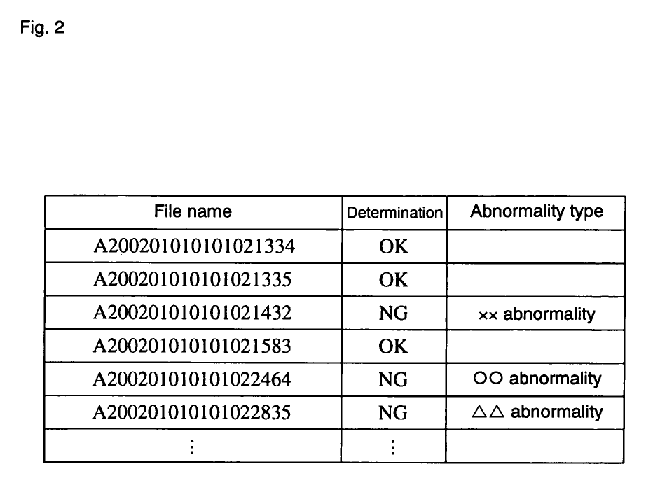

The inspection achievement file 2 contains the description of the actual result of normality/abnormality decision for each data of each sensor data file 1. The information on the abnormality type (name or abnormality code) is also added to the abnormal data. A specific example of the data structure is shown in FIG. 2. The normality/abnormality decision is performed by the inspector (person) or can be prepared or corrected based on the subsequent abnormality information of the object. The sensor data 1 and the data included in the inspection achievement file 2 make up the sample data.

The default inspection condition file 3 contains the description of the initial set value at the time of starting the search of the various parameters, and the feature amount value is calculated based on this inspection condition. Also when the person searches the various parameters, the search is started with the inspection condition as a default.

The input unit 4 is a device by which the person inputs each parameter for the search, and may include a keyboard, a mouse or any of other various input devices. The information actually input are (1) input file information (inspection achievement file name, sensor data storage position), (2) search finish conditions, including (a) assessment value threshold exceeded, (b) assessment value saturated and (c) designated search time (generation), and (3) search method, including (a) separation degree given priority, and (b) number of separations given priority.

The internal units include an inspection achievement file reader 11, a feature amount calculation unit 12, an assessment unit 13, a search condition setting unit 14, a parameter search unit 15, a search finish conditions determining unit 16 and an inspection condition output unit 17. The specific function of each of these processing units described below.

First, the search condition setting unit 14 receives the search method (separation degree/number of separations), the search finish conditions, the search devices (GA, NN, diallele cross, SVM) from the input unit 4 and set them in each corresponding unit.

The inspection achievement file reader 11 acquires each information input from the sensor data 1 and the inspection achievement file 2. Specifically, the inspection achievement (normality/abnormality decision, conformity/nonconformity) described in the inspection achievement file 2 are arranged with the corresponding file names, and the conformity and nonconformity files of the inspection achievement are read respectively. In this case, the information once stored in file such as “the sensor data” and “the inspection achievement file” are used. Nevertheless, the inspection achievement can be input each time from an input device or other external devices each time of measurement. Also, the sensor data 1 can be input directly without the intermediary of the file and held internally.

The data acquired in the inspection achievement file reader 11 is delivered to the feature amount calculation unit 12 in the next stage. In this feature amount calculation unit 12, the data of the default inspection condition file 3 is also produced. The feature amount calculation unit 12, in accordance with the result of search in the parameter search unit 15, updates the various parameters of the inspection condition file and calculates the feature amount for each waveform data file. In the beginning of the process when the data searched by the parameter search unit 15 is absent, the feature amount is determined based on the default value acquired from the default inspection condition file 3. The feature amount thus determined is delivered to the assessment unit 13.

The assessment unit 13, from the result of calculating a plurality of the feature amounts corresponding to each waveform data file, calculates the superiority of the various parameters from the assessment formula described hereinafter, and based on the assessment value thus determined, extracts the name of the feature amounts by which conformity/nonconformity can be distinguished satisfactorily. The assessment formula used is different depending on the designation of the search method. Also, the number of the feature amounts extracted is different depending on the designation of the search method. The search method is acquired from the search condition setting unit 14.

The parameter search unit 15 searches for the various parameters for feature amount calculation that can separate the conforming and nonconforming products in the best way based on the parameters of the inspection condition file. The search methods are various and include GA (generic algorithm), NN (neural network), SVM (support vector machine) and the diallele crossing. The various parameters and the feature amount name highest in assessment value are held.

The search finish conditions determining unit 16 acquires the assessment value from the assessment unit 13 and determines whether the condition for finishing the search given from the input unit 4 is met or not. Once the search finish conditions are met, the search finish is notified to the parameter search unit 15.

The parameter search unit 15 outputs the most excellent various parameters searched by itself to the inspection condition file, while at the same time determining the name of the feature amount for separating the conformity and nonconformity in the best way and delivering it to the search condition output unit 17. The search condition output unit 17 outputs the most excellent various parameters delivered from the parameter search unit 15 and the name of the feature amount for separating the conformity and nonconformity in the best way.

The data output from the search condition output unit 17, on the other hand, includes the effective feature amount name for designating the feature amount which separates the conformity/nonconformity of the sensor data in the best way and the inspection condition file storing the various parameters for calculating the particular effective feature amount. The names of the top n effective feature amounts are presented (n: positive integer including 1).

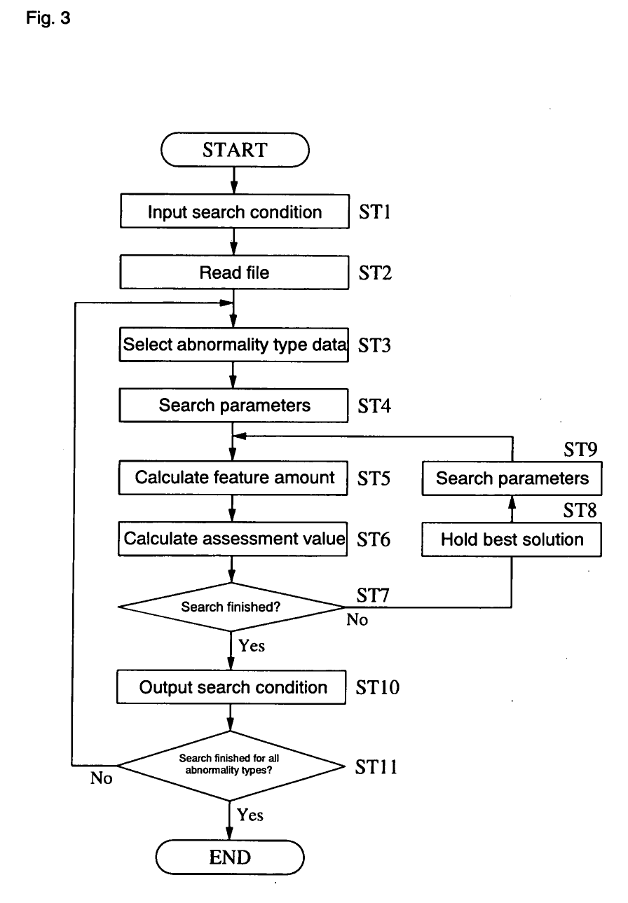

Next, the operating principle of the above-mentioned system is explained together with the detailed functions of each processing unit as required. The overall processing algorithm is shown in the flowchart of FIG. 3.

First, the search condition setting unit 14, upon receipt of the search condition from the input unit 4, applies the received search condition to the related processing units (ST1). The parameter search can use various algorithms, and in the case where the generic algorithm is used, the following search conditions are given by the user.

The parameters for defining the operation based on the generic algorithm includes the population, crossover rate, mutation rate and the number of generations. The population is the number of individuals (solution candidates). The crossover rate is the probability of crossing the individuals. The mutation rate is the probability of mutation of genes in the individuals. The number of generations is the number of generations for which the generic algorithm is used. The parameters defining the search method include the selection of which is emphasized, the separation degree or the number of separations. In the case where the number of separations is emphasized, the number of the leading separations used and the weight coefficient make up the parameters. Further, the parameters (finishing condition) defining the search finish conditions include (1) the time point at which the number of generations for the generic algorithm is reached, (2) the time point at which the assessment value ((2) or (2)′ described later) exceeds a predetermined value, or (3) the time point when the generations having the same assessment value exceed a predetermined number. The search condition is assumed to be met in the case where at least one of these parameters is secured.

The inspection achievement file reader 11 acquires the inspection achievement file name and the sensor data file directory to be collected from the search condition setting unit 14, and reads the file of the file name described in the inspection achievement file. After reading, the conformity/nonconformity operation of the inspection achievement file 2 are arranged with the corresponding sensor data file names (ST2).

Next, the sensor data files of the nonconforming products are totalized for each nonconformity type (abnormality type) (ST3). Specifically, as shown in FIG. 2, the data files of the inspection achievement file in which the determination result is nonconforming (abnormal) are registered with related abnormality types, and therefore the data files having the same abnormality type are formed into a group. Each time of access, a sensor data file containing all the conforming products and a sensor data file containing a single nonconformity type (the sensor data file containing the same abnormality type) are prepared as a set.

After that, the parameter search unit 15 acquires the default parameter through the feature amount calculation unit 12 and searches for the parameters (ST4). The various parameters resulting from the search are delivered to the feature amount calculation unit 12.

Next, the feature amount calculation unit 12, based on the parameters received from the parameter search unit 15, calculates and determines the various feature amounts as disclosed, for example, in Japanese Unexamined Patent Publication No. 11-173909 (ST5). This calculation is performed for all the conformity sensor data selected at step 3 and the data of the files of a given single nonconformity type, and the calculation value (feature amount) thus determined is sent to the assessment unit 13.

The assessment unit 13 totalizes the result of the feature amount calculation for each of the conforming products and the nonconforming products, and calculates the assessment value for each feature amount number indicated in equation (1). Once the “separation degree” is designated as a search type, the assessment value Val is established by equation (2). In the case where the “number of separations given priority” is designated, on the other hand, the assessment value Val is established by equation (2)′.

Specifically, the assessment value for each feature amount is determined using equation (1) first of all. In this case, the coefficient α is to increase the value in the case where the average of the sensor data (hereinafter referred to as the conforming products) determined as conforming in the inspection achievement file is smaller than the average of the sensor data (hereinafter referred to as the nonconforming products) determined as nonconforming in the inspection achievement file, i.e. in the case where the nonconforming products are detected as a high value. The coefficient β, on the other hand, is to add the value in the case where the conforming product group and the nonconforming product group are completely separated from each other. Equation (1) is only an example, and other equations may apply.

$$Vn = α * β * ( NGAven - OKAven ) / OK σ n ) \\ where \\ 0 \text{:} OK σ = 0 \\ \begin{matrix}σ = & 100 \text{:} OK σ n > 0 AND ( NGAven - OKAven ) > 0 \\ & - 10 \text{:} OK σ n > 0 AND ( NGAven - OKAven ) <= 0\end{matrix} \\ \begin{matrix}β = & 2 \text{:} ( NG Min n - OK Max n ) > 0 \\ & 1 \text{:} ( NG Min n - OK Max n ) <= 0\end{matrix} \qquad ( 1 )$$

where OKAven is the average value of the feature amount n of the conforming products, OKσn the variance of the feature amount n of the conforming products, NGAven the average value of the feature amount n of the nonconforming products, NGσn the variance of the feature amount n of the nonconforming products, OKMinn, OKMaxn the maximum and minimum values, respectively, of the feature amount n of the conforming products, NGMinn, NGMaxn the maximum and minimum values, respectively, of the feature amount of the nonconforming products, and n=0—number of feature amounts −1.

The final assessment value Val is determined in the manner described below. Specifically, as to the assessment value Val, equations (2) and (2)′ are used for different applications by the search method designated by the user. In the case where the search method is “separation degree given priority”, equation (2) is used, while in the case where the search method is “number of separations given priority”, on the other hand, equation (2)′ is used. Equation (2)′ uses the highest two assessment values Vn, and may alternatively use the weighted average of the arbitrary leading assessment values.
Val=Vm (2)
where Vm is MAX (Vn: n=0 to number of feature amounts −1)
Val=(w*Vm+(1−w)*Vk)/1 (2)′
where Vm is MAX (Vn: n=0 to number of feature amounts −1), Vk is MAX (Vn: n=0 to number of feature amounts −1, excepting m), and w is 0.0 to 1.0 (weight set by user)

Once the assessment value is determined according to each equation described above, the search finish conditions determining unit 16 checks whether the search finish conditions are established or not (ST7). The search finish conditions are set from the search condition setting unit 14 by executing step 1. This condition is met, for example, in the case where the assessment value reaches a predetermined level, or the number of generations reaches a predetermined value. In the case where the search finish conditions are not met, the process proceeds to step 8 to maintain the best solution. Specifically, the parameter search unit 15 receives the assessment value from the assessment unit 13, and in the case where the assessment value of the present various parameters is maximum, the maximum assessment value is updated, and the present various parameters are held as the best solution candidate.

Further, the parameter search unit 15 makes the next search for the various parameters based on the assessment value, and delivers the search result to the feature amount calculation unit 12 (ST9). After that, the process returns to step 5, where the feature amount is calculated based on the new various parameters by the feature amount calculation unit 12.

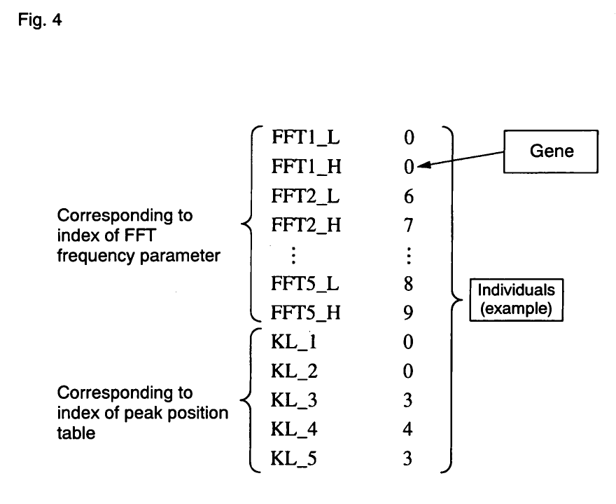

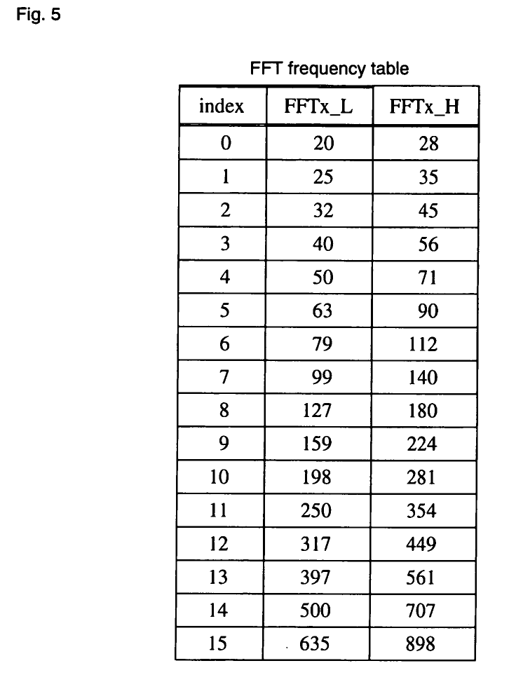

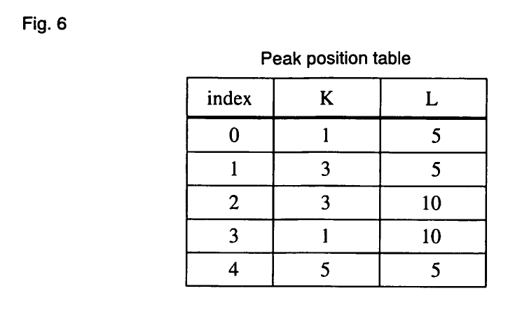

The function of the parameter search unit 15 is explained. An example of coding of individuals in the case where the generic algorithm is used for the parameter search unit 15 is shown in FIG. 4. The value of each gene in this coding corresponds to the table index in FIGS. 5, 6. In this case, the feature amount is employed as the average value of L units from the Kth unit defined by KL_x for the FFT frequency spectrum peak in the frequency range of FFT_Lx to FFTx_H.

In the case where x=2, for example, FFT2_L (FFT low-limit frequency) and FFT2_H (FFT upper-limit frequency) indicate that the FFT frequency spectrum between 79 Hz and 140 Hz is calculated as a feature amount, where KL_2 indicates that the first five units of the frequency spectrum peaks obtained by KL_2,FFT2_L, FFT2_H are averaged.

Similarly, in the case where x=1, FFT1_L and FFT1_H are both zero. Therefore, the FFT frequency spectrum between 20 and 28 Hz is determined, and the first five frequency spectrum peaks are averaged.

A multiplicity of gene individuals coded as above are generated at random as an initial population, and using the generic algorithm, selection, appropriate crossover and mutation operation are performed to search for the parameter constituting the optimum solution. The parameter search unit 15 performs the generic operation such as selection, crossover and mutation according to the generic algorithm and generates genes (various parameters) of a new generation.

The generic algorithm used herein is also widely used. Specifically, the initial (zero generation) population is formed based on the operating conditions (population, number of generations, etc.) set by the search condition setting unit 14. Based on the various parameters set in this way, the feature amount is determined by the feature amount calculation unit 12 and assessed by the evaluation unit 13.

Next, two excellent individuals are selected from the present population. This selection is to make the individuals adapted to the environment survive, and the individuals high in assessment value have a high probability of survival. According to this embodiment, the roulette method is employed for individual (parent) selection. In the roulette method, the probability of selection is proportional to the assessment value of the individual. Specifically, assume that the indexes to identify an individual are 0 to n, and the assessment value of the individual i is fit (i). Then, the individual j satisfying the following equation is selected.

$$T\_val = RAND ( 1 ) \times {\sum }_{i = 0}^{n} fit ( i ) \\ {\sum }_{i = 0}^{j} fit ( j ) > T\_val \\ where \\ j \text{:} 0 = > j >= n \\ 0 <= RAND ( 1 ) < 1.0 \qquad [ Expression 1 ]$$

In other words, the numerical values (T_val) less than the total of the assessment values is generated at random. Next, the assessment values are added in the order of index, and an individual having the index exceeding T_val is selected.

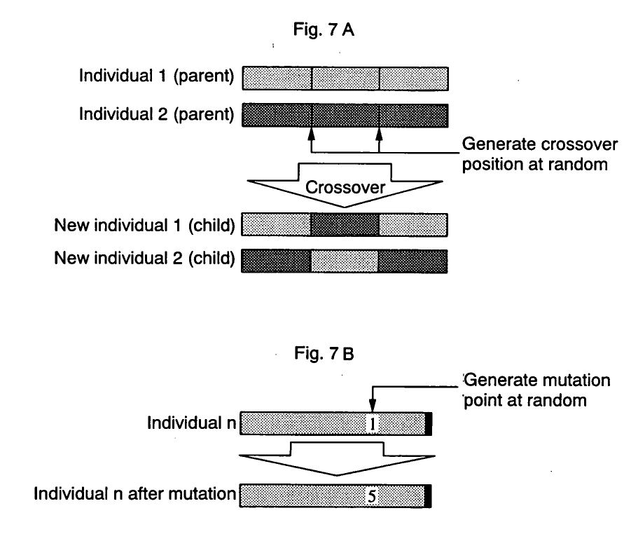

In the case where the crossover probability is exceeded, the crossover is carried out. In other words, from the two individuals (parents) selected in the above-mentioned way, a new individual (child) is generated. The crossover method employs the two-point crossover. Specifically, as shown in FIG. 7A, the crossover points are determined at random, the data on the crossover points are exchanged with each other. The new individual is generated in this way from two excellent parents and therefore estimated to succeed to the excellent characters of the parents.

In the case where the mutation rate is exceeded, on the other hand, the individuals are subjected the mutation. The mutation is the operation by which the character not owned by the parent individuals is generated in the child individual. Specifically, as shown in FIG. 7B, the value of the genes at the mutation points determined at random is replaced by a mutation value determined at random. The mutation value is generated at random within the range between upper and lower limits of the selected genes. In the case show in FIG. 4, for example, the first to tenth individuals for specifying the FFT frequency parameter are determined within the range of 0 to 15, and the last five for specifying the peak position table are determined in the range of 0 to 4.

Two individuals lowest in assessment value are selected, and replaced with the new individuals generated by crossover or mutation. As a result, the generation is changed. This process is executed for all the individuals. The best individual can be determined by repeating this generation change an appropriate number of times.

Specifically, the mth feature amount corresponding to Vm when the maximum Val is obtained as a calculation value among the searches (ST4 to ST9) for one nonconforming type separates the conforming and nonconforming products in the most satisfactory way. In the case where equation (2)′ is selected, on the other hand, the feature amounts corresponding to Vm and Vk when the maximum Val is obtained as a calculation value correspond to TOP1 and TOP2 of the feature amounts best adapted to separate the conforming and nonconforming products from each other.

In the case where the branching decision at step 7 is YES, on the other hand, the parameter search ends. Therefore, the search condition output unit 17 outputs the feature amount highest in assessment value and the various parameters for calculating the particular feature amount (ST10). The output data are printed out, displayed on the display unit or held in a predetermined storage medium. Further, the parameters may be set directly in the noise inspection system.

The feature amount and the parameter for determining the presence or absence of noises are varied from one abnormality type to another. The process described above, therefore, is executed for each abnormality type. Whether the search is finished for all the abnormality types is checked (ST11), and if not completely searched, the process returns to step 4 to execute the process for the next abnormality type. In the case where the search is finished for all the abnormality types, on the other hand, the search operation is ended.

According to this embodiment, the various parameters for calculating a plurality of effective feature amount candidates are searched based on the assessment function, so that an effective feature amount and the various parameters for calculating the particular feature amount can be discovered at the same time. As a result, the number of the time consuming processes executed in the prior art based on the intuition and experiences of the analyzer can be saved.

Depending on the type described above, the conformity/nonconformity (normality/abnormality) may not be determined by one effective feature amount alone. In such a case, the search method for separation with a single feature amount may fail in search. Thus, two search methods are selectively employed, including (1) a method to search the feature amount for separating conforming from nonconforming products in the best way, and (2) a method to search a plurality of feature amounts for separating conforming from nonconforming products (assessment formulae (2) and (2)′). In this way, both cases can be dealt with, a case in which a single effective feature amount is sufficient, and a case in which a plurality of effective feature amounts are required.

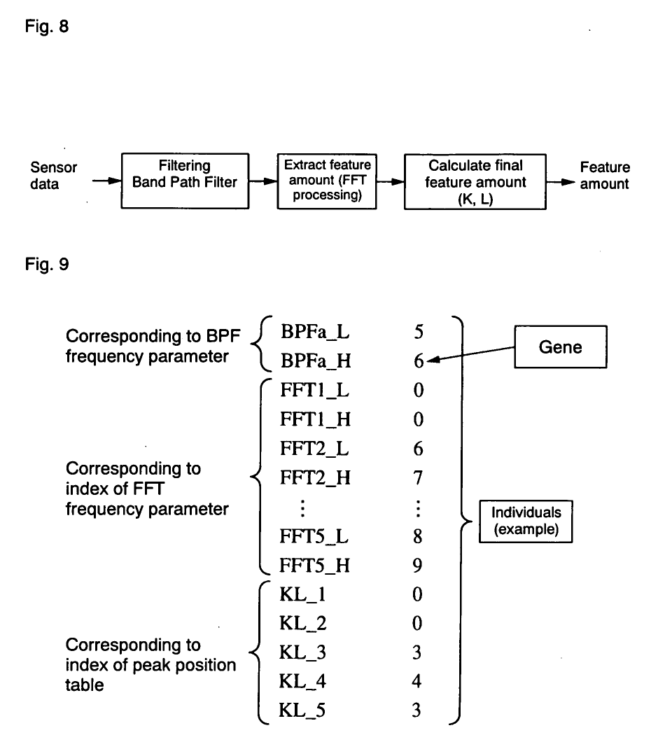

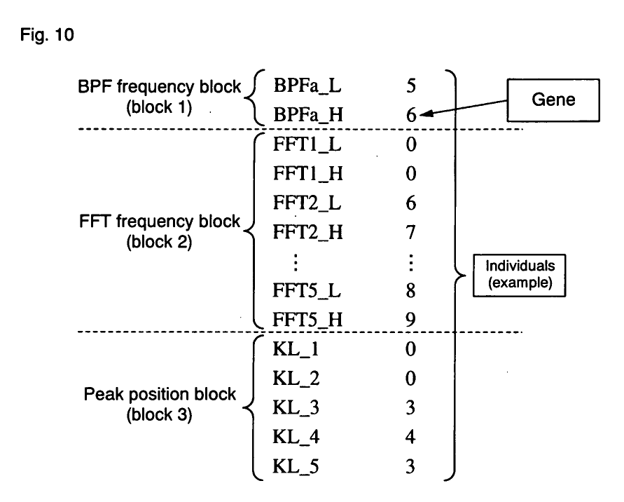

FIG. 8 and subsequent drawings show a second embodiment of the invention. In the feature amount calculation for the noise inspection system, assume that the various parameters to calculate the feature amount determined by the steps of filtering, feature extraction and the final calculation of the feature amount as shown in FIG. 8 are determined by the generic algorithm. Up to the process of filtering, the gene coding as shown in FIG. 9 is conceivable.

The individuals coded as described above using the simple generic algorithm are subjected to the crossover and mutation operation to search for the parameters. In the feature amount calculation as shown in FIG. 8, however, the parameters for filtering may affect the parameters for feature extraction, which in turn may affect the parameters for overall feature amount calculation. In the case where the various parameters for the processes not independent of each other are determined, the simple use of the generic algorithm poses the problems described below.

(1) The parameters are dependent on each other and therefore the search completion may consume a long time (in some cases the search over a wide area may of course be desired at the sacrifice of consumption of a long time. (2) Although fixing some parameters may be more efficient than the random search of all, this is impossible with the simple GA. (3) In the hierarchical GA or parallel GA considered suitable to deal with a complicated case, the GA operation cannot be controlled easily and considerable trials and errors are involved to acquire the optimum operating condition.

In view of this, according to this embodiment, to solve the three problems described above, a mechanism of “concealment/manifestation of the generic character for each block”, “block crossover” and “block mutation” is introduced for the simple GA. In other words, the gene coding is blocked for each function. The coding shown in FIG. 9, for example, can be divided into three blocks including a first block corresponding to the filtering process, a second block for determining the feature amount and a third block for determining an overall feature amount. In each block, the character concealment/manifestation is controlled. Specifically, the block with the character concealed is not affected by the crossover and the mutation. Also, regardless of the value of the genes in the block, a fixed value is returned as a decode value at the time of decoding. This fixed decode value may be a default value or designated by the user. The block with the character manifested, on the other hand, is processed with the normal generic algorithm.

The character manifestation/concealment for each block is designated by the user as the search condition by operating the input unit 4. Specifically, the user designates any of the following items for each block:
(1) Constant manifestation (same as normal GA)
(2) Manifestation of the number of generations (concealed until the time point of manifestation when the designated number of generations is reached).
(3) Manifested at the time point when the assessment value exceeds a predetermined value.
(4) Manifested at the time point when the saturation of the assessment value is detected (the saturated in the case where the assessment value remains unchanged for more than a predetermined number of generations).

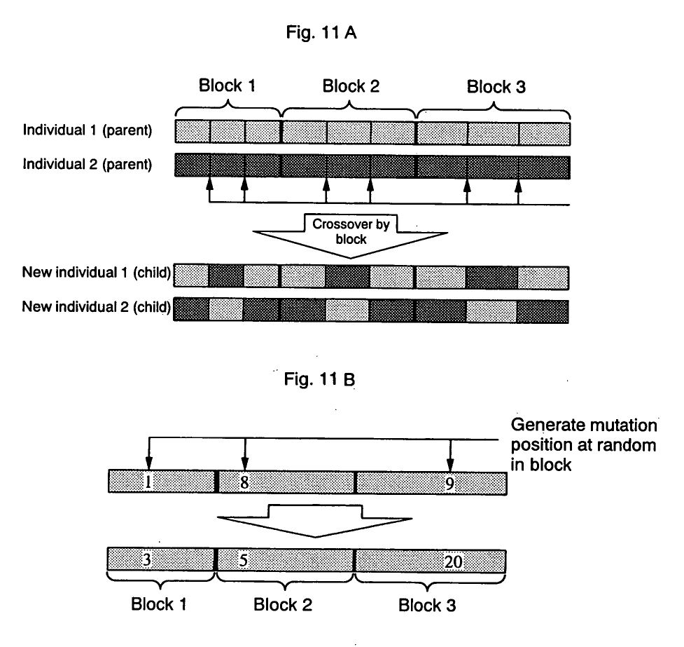

The generic operation including the selection, crossover and mutation conducted with the generic algorithm by the parameter search unit 15 is carried out for each block. Specifically, in the crossover by block, for example, as shown in FIG. 11A, the interior of the block is regarded as one individual, and the crossover point is generated at random in the block, so that the individuals cross each other. In the process, the blocks with the character concealed are not crossed over.

The mutation by block, on the other hand, as shown in FIG. 11B, is carried out regarding the interior of the block as one individual. The mutation is not conducted for the blocks with the character concealed (described later).

As described above, the versatile search is made possible by setting the block-based generic character manifestation/concealment and introducing the block-based crossover and the block-based mutation. Specifically, assuming that the block 1 is constantly manifested, the block 2 manifested 10 generations later and the block 3 manifested after saturation of the assessment value, for example, the reducing search is made possible for the filtering process, the feature amount extraction and the overall feature amount calculation in that order. Also, in the case where all the blocks are constantly manifested, the wide-area search is made possible as in the normal GA. In this way, the interdependence of the parameters for the feature amount calculation can be incorporated into the search strategy.

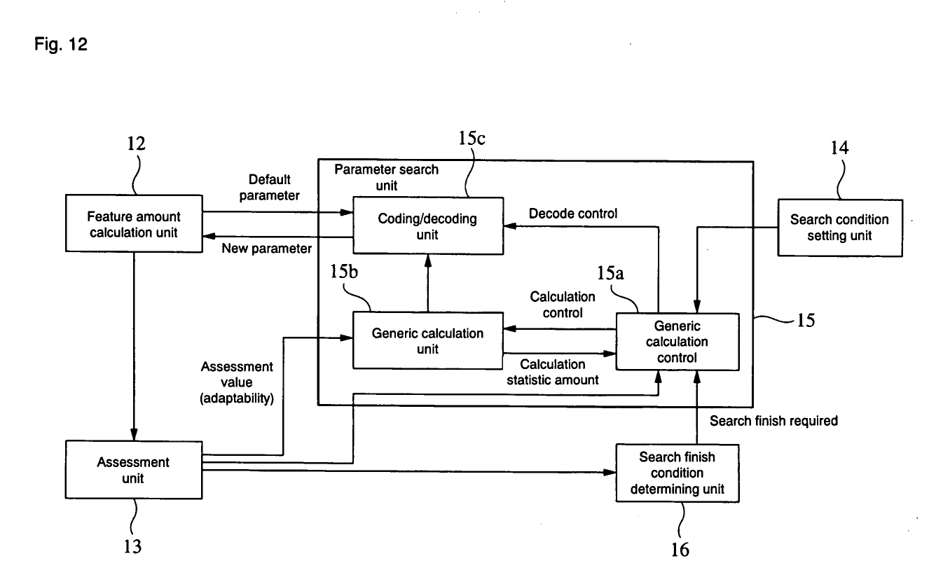

The parameter search unit 15 for executing this process can be configured as shown in FIG. 12. As shown in FIG. 12, the parameter search unit 15 according to this embodiment includes a generic calculation control unit 15a, a generic calculation unit 15b and a coding/decoding unit 15c.

The generic calculation control unit 15a controls each block based on the user setting. Specifically, the timing of manifestation/concealment is monitored for each block, the permission/non-permission of the generic calculation for each block is output as the calculation control information to the generic calculation unit 15b. Also, the decode control signal is output to the coding/decoding unit 15c.

Also, the generic calculation unit 15b conducts the generic calculation for crossover, selection and mutation. This function is also shared by the first embodiment, except that in this embodiment, the generic calculation is conducted for each block. In accordance with the instruction from the generic calculation control unit 15a, no generic calculation is made for the block to be concealed.

The coding/decoding unit 15c decodes an individual (based on the list shown in FIGS. 5, 6) and converts it into the various parameters for the feature amount calculation. In accordance with the control operation of the generic calculation control unit 15a, the block to be concealed is decoded to the designated default value or the value designated by the user.

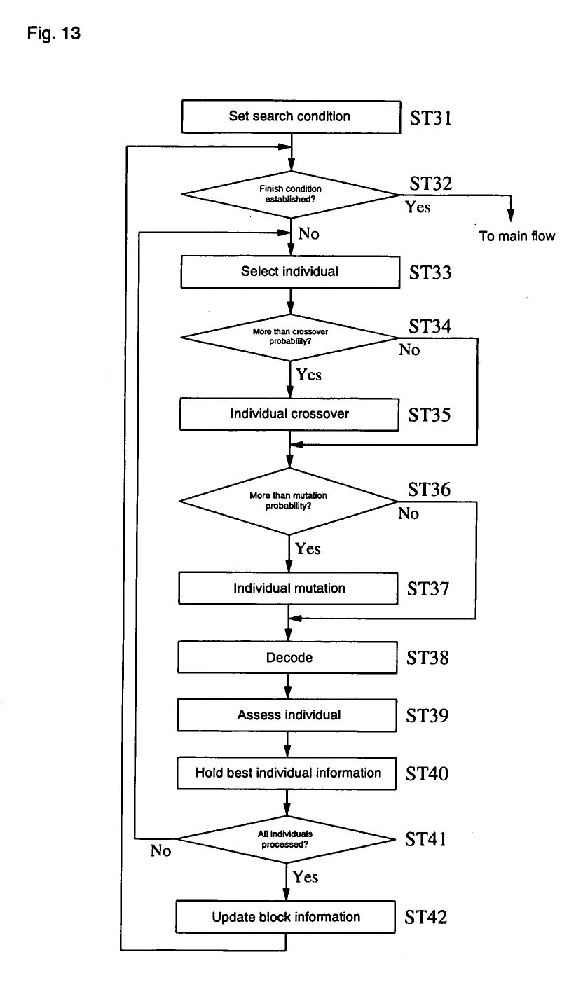

The function of the parameter search unit 15 having the processing units 15a to 15c is to execute the steps shown in the flowchart of FIG. 13. The flowchart shown in FIG. 13 corresponds to the specific process of step 9 in the main flowchart shown in FIG. 3. After this process, therefore, the control skips to step 5.

First, from the search conditions input by the user operating the input unit 4, the character manifestation/concealment information is set for each block. Also, the search finish conditions are set (ST31). These processes are executed by the generic calculation control unit 15a.

The generic calculation control unit 15a checks whether the set search finish conditions are met or not (ST32), and in the case where such a condition is so met, the process is ended and returns to the main flow. Otherwise, the generic calculation control unit 15a selects two individuals (parents) from the population. The criterion for selection is similar to that of the first embodiment.

Next, the crossover probability for the selected individual is calculated by the generic calculation unit 15b, and in the case where it is more than a designated value, the two individuals are crossed with each other block by block thereby to generate two new individuals (children). Nevertheless, the individuals for the blocks with the character concealed are not crossed. The information on the character concealment/manifestation is acquired from the generic calculation control unit 15a (ST34, 35).

The generic calculation unit 15b calculates the mutation probability of the selected individual, and in the case where the mutation rate is exceeded, the mutation is carried out for each block. However, no mutation is carried out for the blocks with the character concealed. The information on the character concealment/manifestation is acquired from the generic calculation control unit 15a. The mutation operation is performed for each individual (ST36, 37).

The coding/decoding unit 15c decodes each individual into the form of the various parameters for feature amount calculation. In the process, the genes are not directly decoded but into the default value or the value designated by the user for the blocks with the character concealed. The information on the character concealment/manifestation is acquired from the generic calculation control unit 15a (ST38).

Next, the individuals are assessed (ST39). Specifically, the assessment value of each individual decoded is acquired from the assessment unit 13. In the case where the assessment value is maximum, the assessment value and the individual with the maximum assessment value are held (ST40).

It is determined whether the process is complete or not for all the individuals (ST41). In the presence of an unprocessed individual, the process of steps 33 to 41 is executed. In this way, one generation is finished at the time point when the process of steps 33 to 41 is repeated for all the individuals in the population.

The generic calculation control unit 15a checks whether the concealment/manifestation condition is met for each block each time the process of one generation is completed, and in the case where the condition designated by the user is met, the concealment/manifestation condition for each block is updated (ST42).

According to this embodiment, the mechanism of the generic character concealment/manifestation for each block, the block crossover and the block mutation is introduced into the search using the generic algorithm. Therefore, the intentional search corresponding to the property (interdependence, etc.) of the various parameters to be searched can be easily incorporated, resulting in an improved search efficiency. The other parts of the configuration and the operational effect are similar to those of the first embodiment and therefore not described.

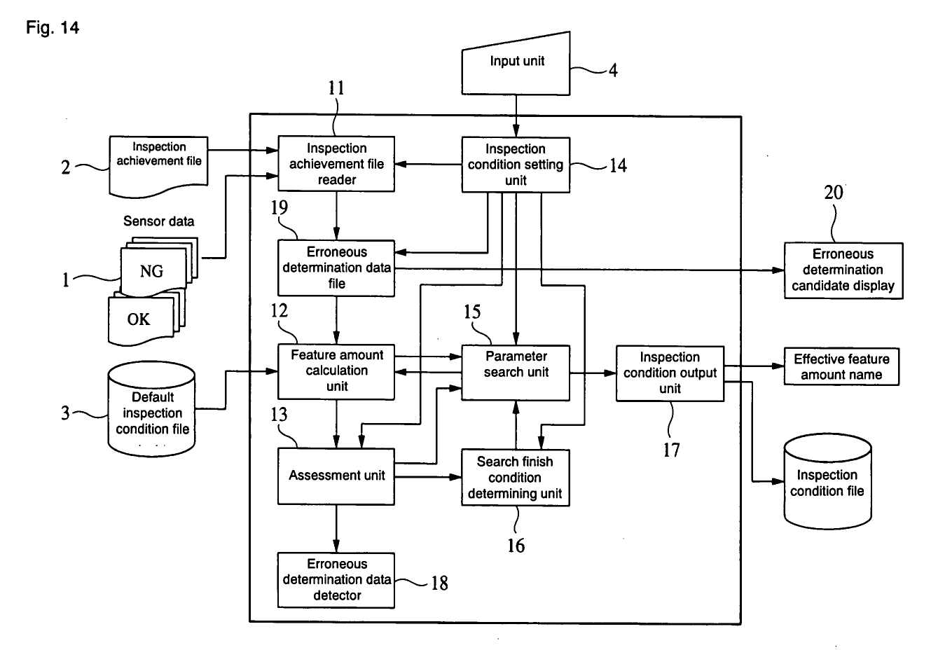

FIG. 14 shows a third embodiment of the invention. In the first and second embodiments, the waveform file containing the description of conformity (OK) and nonconformity (NG) in the inspection achievement file is used directly to determine the feature amounts separable into conformity and nonconformity and the various parameters for calculating the feature amounts. This is based on the assumption that the conformity/nonconformity decision described in the inspection achievement file 2 is correct. In view of the fact that the conformity/nonconformity decision is made by a person from the waveform data making up the basis of the inspection achievement file, however, such a conformity/nonconformity decision may contain an error.

In the case where the feature amount and the various parameters for calculating the feature amount are searched while containing an error, therefore, the search may fail or the completion of the search may consume a long time. In view of this, according to this embodiment, the determination result (conformity/nonconformity) which may have been erroneously made by the user is detected, and the data which may have been erroneously determined is deleted or the determination result is changed for reassessment, thereby finally judging whether an erroneous determination is involved or not. In the case of an erroneous determination, the determination is corrected as required thereby to realize an efficient parameter search. Further, the function is added to present to the user the data file name estimated as the erroneous determination by the user, so that the reconsideration is possible on the part of the user.

A specific system configuration for realizing this function, as shown in FIG. 14, is based on the configuration of the first embodiment. Further, an erroneous determination data detector 18, an erroneous determination data filter 19 and an erroneous determination candidate display unit 20 are added to this configuration.

The erroneous determination data detector 18 is to extract the sensor data of the erroneous determination candidate until the finish condition is met from the start condition designated by the user. In the case where the assessment value is improved as the result of processing (described later) the erroneous determination data as designated by the user, the erroneous determination candidate is finally determined as an erroneous determination and the erroneous determination data file 19 is notified.

The detection start conditions and the finish conditions for the erroneous determination candidate are designated by the user through the input unit 4. The detection start conditions that can be designated include:
(1) The time point at which the search has passed a predetermined generation (for GA) or a predetermined length of time (number of times).
(2) The time point when the improvement of the assessment value stops for a predetermined generation (number of times/time length).
(3) Not executed.

The conditions for finishing the erroneous determination detection include:
(1) The time point (synchronous with search finish) when the generation (GA), time or number of times to finish the search arrives.
(2) The time point when the erroneous determination candidate detected and finally determined reaches a % of the total number of data files (a % can be set arbitrarily by the user).

The erroneous determination data filter 19 processes the erroneous determination data candidate detected by the erroneous determination data detector 18 in accordance with the user instruction. The user instruction includes:
(1) The erroneous determination candidate is entered into a determination group of the opposite determination to (different determination from) the present determination.
(2) The erroneous determination candidate is removed. In other words, the data such as the inspection achievement file acquired by the inspection achievement file reader 11 is filtered as designated and delivered to the feature amount calculation unit 12.

The erroneous determination candidate display unit 20 displays to the user the manner in which the erroneous determination data file name output from the erroneous determination data filter 19 and the file thereof are processed ((1) and (2) above).

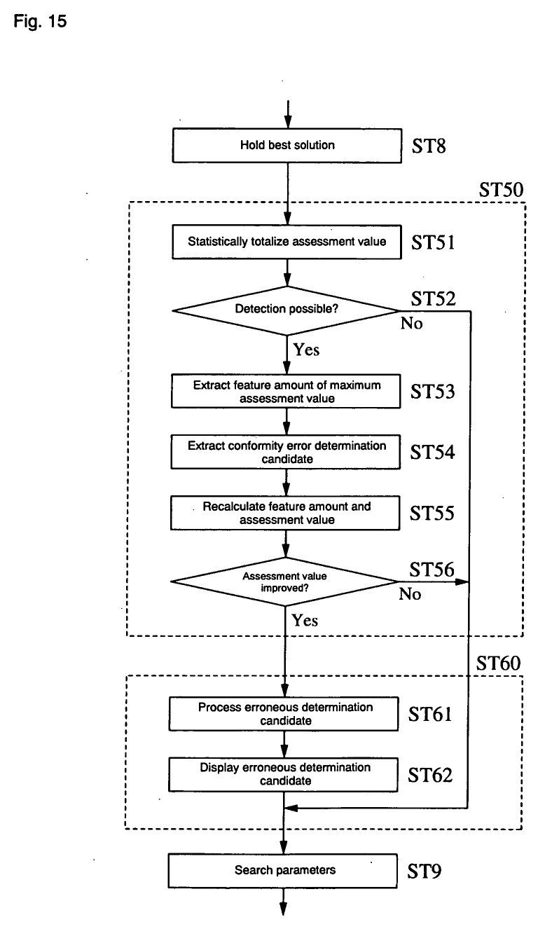

The processing algorithm according to this embodiment is shown in FIG. 15. The flowchart shown in FIG. 15 indicates the feature portion of this embodiment which is not illustrated, and the processes before and after the particular portion are similar to the corresponding processes shown in FIG. 3. Only the feature point is explained. After executing the process for holding the best solution at step 8, the process is executed to select the erroneous determination candidate (ST50).

First in the erroneous determination candidate select process, the erroneous determination data detector 18 measures the number of generations, time and the number of searches during which the assessment value of the best solution remains unchanged (ST51). Next, the advisability of executing the process of extracting the erroneous determination candidate is determined (ST52). The time from start to finish of the erroneous determination candidate is described above. Unless the condition is not met, the absence of the erroneous determination can be estimated, and therefore the process proceeds to the parameter search at step 9. Once the condition is met, on the other hand, the process proceeds to the extraction of the erroneous determination candidate.

Specifically, the feature amount with the highest separation degree (Vm in equation (2)) with the best solution is selected (ST53). For the feature amount m specified at step 53, the average value (OKAven) of the feature amount m for the conforming products and the variance (OKσn) of the feature amount m for the conforming products are determined. The sensor data determined as conforming (normal) which has the feature amount larger than OKAven+3*OKσ is extracted. In the case where a plurality of sensor data are available, the one having the largest feature amount is extracted. The extracted sensor data is set as an erroneous determination candidate (ST54).

The sensor data of the erroneous determination candidate is processed by the processing method designated by the user (removed or set in the opposite determination) thereby to calculate the assessment value again. Also, from the feature amounts of the conforming and nonconforming products, the assessment value (equation (2) or (2)′) is calculated (ST55) thereby to determine whether the assessment value is improved or not (ST56). In the case where the assessment value is yet to be improved, the determination is not considered erroneous, and therefore the process proceeds to step 9 as it is thereby to search the parameters for the next assessment.

In the case where the assessment value is improved, on the other hand, the erroneous determination candidate is finally determined as an erroneous determination, and the erroneous determination candidate is notified to the erroneous determination data filter 19, followed by processing the erroneous determination candidate (ST60). Specifically, first in the erroneous determination data filter 19, the sensor data making up the erroneous determination candidate is processed in such a manner that it becomes effective in the subsequent parameter search in accordance with the user setting. In the case where the removal is designated, the sensor data file of the erroneous determination candidate is not used in the subsequent search. In the case where the opposite determination is involved, on the other hand, the opposite determination is involved in the assessment value calculation of the subsequent parameter search. In this way, the information of the inspection achievement file is updated (ST61)

Next, the sensor data file name of the erroneous determination candidate and the process (removal or included in opposite group) are displayed to the user (ST62). The configuration and the operational effects of the other parts are similar to those of each embodiment described above and not explained.

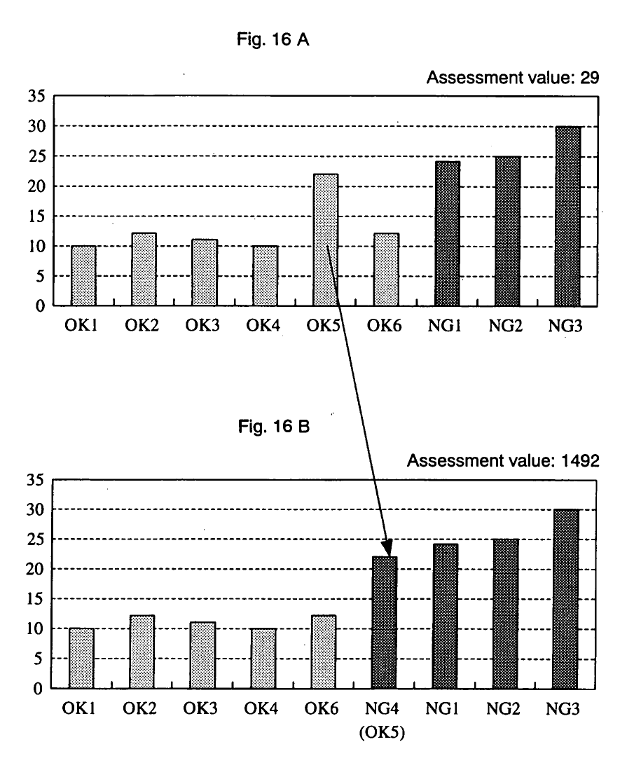

According to this embodiment, assume that the feature amount before the erroneous determination extraction is as shown in FIG. 16a. The abscissa represents the data file name and the ordinate the feature amount. The data “OK5” indicating the conforming product determined by the person is finally judged as erroneous determination, and replaced by the data “NG4” for the nonconforming product thereby to calculate the feature amount again. In this way, the assessment value is determined as shown in FIG. 16b. Even in the case where the same feature amount and the various parameters are used, the assessment value is improved to 1492 after the erroneous determination extraction from 29 before the erroneous determination extraction.

As described above, according to this embodiment, the data statistically estimated as an erroneous determination is removed or included in the opposite (or different) determination group thereby to alleviate the risk of reducing the search accuracy and the search efficiency due to the human erroneous determination. Also, as a display of the erroneous determination candidate, the result as shown in FIG. 16 is presented to the user and thus the user is given the chance of reviewing the data.

According to the embodiment described above, the erroneous determination candidate is searched only on the part of conformity, to which the invention is not limited, and the erroneous determination candidate for nonconformity can be extracted or the erroneous determination candidates for both conformity and nonconformity can be extracted.

Also, according to this embodiment, the erroneous determination candidate larger than OKAven+3*OKσ is detected. In order to adjust the strictness of erroneous determination candidate detection, however, the erroneous determination candidate larger than OKAven+q*OKσ may be detected, where q can be designated by the user.

Further, taking into consideration the case in which the variance of the conformity group and the nonconformity group has no single peak, the equation for erroneous determination detection can be set arbitrarily. Further, according to this embodiment, the erroneous determination candidate is extracted and the erroneous candidate processed automatically. As an alternative, an interactive interface can be used in which the extracted erroneous determination candidate is presented to the user and the subsequent process is selected by the user.

In the case where the data on the erroneous determination candidate is a nonconforming product, it may not be included in the conforming sample but in a group of a different nonconformity type. In this case, as long as the search of the various parameters for the nonconformity type with the nonconforming product added thereto is finished, the accuracy of the search result can be improved by executing the search again.

Each of the processing units described above can be implemented by an application program. In each of the embodiments described above, therefore, each function is explained as a device mounted on the computer or the like. This invention, however, is not limited to such devices, but may be the software (program product) to realize the required processing function. This program product can be distributed using various communication lines, or distributed after being stored in various storage media.

It will thus be understood from the foregoing description that according to this invention, an effective feature amount suitable for determining the normality/abnormality of an object to be inspected in the inspection/diagnosis apparatus and the various parameters for calculating the particular effective feature amount can be easily searched and determined.

1. A knowledge generation support system for an inspection/diagnosis apparatus to determine whether an object of inspection is normal or abnormal based on feature amount data obtained by a filtering process and a feature amount extraction process executed on acquired measurement data, wherein an effective feature amount suitable for the object of inspection and various parameters for calculating the effective feature amount are determined, the system comprising:
a search unit for searching for various parameters to search for the various parameters for calculating a feature amount,
a feature amount calculation unit for calculating a plurality of feature amounts based on the various parameters obtained in the search unit from a given sample data containing normal and abnormal data, and
an assessment unit for outputting, as an assessment value, an excellence of the various parameters from a result of assessment of the feature amount determined by the feature amount calculation unit,
wherein the search unit searches the various parameters again based on the assessment result of the assessment unit thereby to determine an effective feature amount high in assessment value and the various parameters for the particular effective feature amount.

2. A knowledge generation support system according to claim 1,
wherein methods of searching the various parameters in the assessment unit include:
(1) A method in which a degree of ability to separate the normality and abnormality is emphasized, and
(2) A method in which a number of the feature amounts separable is emphasized,
wherein one of the methods is selectively executable, and in accordance with the selected search method, one type described below is determined,
(1) An effective feature amount of which normality and abnormality can be separated from each other most effectively and various parameters for calculating the effective feature amount, and
(2) A plurality of effective feature amounts for separating normality and abnormality from each other and various parameters for calculating the effective feature amounts.

3. A knowledge generation support system according to claim 1,
wherein the sample data is divided into the abnormal data and the normal data for the same abnormality type.

4. A knowledge generation support system according to claim 1,
wherein the search unit searches for the optimum various parameters by executing crossover, mutation and selection operation until desired conditions are met, using a generic algorithm for individuals with the various parameters coded, and
wherein genes of each coded individual are blocked by function and manifestation or concealment of the gene character is controlled by block.

5. A knowledge generation support system according to claim 1,
comprising a function in which in a case where the search with the various parameters using all the sample data satisfies desired conditions, data that can be estimated as an erroneous determination is extracted from the sample data, and in a case where the assessment value obtained by determining the various parameters using the sample reconstructed while the data estimated as an erroneous determination is regarded as an erroneous determination is higher than the assessment value before the reconstruction, the data estimated as an erroneous determination is finally judged as an erroneous determination data.

6. A knowledge generation support system according to claim 5,
wherein the reconstruction is execution of at least one of a process to delete the data estimated as an erroneous determination, a process to replace with sample group of the opposite determination results and a process to replace with a sample group of a different determination result.

7. A knowledge generation support system according to claim 5,
wherein the data finally judged as an erroneous determination is updated to the correct sample data, while the search is executed by the search unit.

8. A parameter search method for a knowledge generation support system for determining an effective feature amount suitable to an object of inspection and calculating the effective feature amount for an inspection/diagnosis apparatus to determine whether the object of inspection is normal or abnormal based on feature amount data acquired by subjecting acquired measurement data to a filtering process and a feature amount extraction process, comprising the steps of:
calculating a plurality of feature amounts based on various parameters set by a feature amount calculation unit with regard to given sample data containing normal and abnormal data,
calculating an assessment value indicating an excellence of the various parameters from a result of calculation of the feature amount determined by the feature amount calculation unit,
searching the various parameters again based on the calculated assessment result,
repeatedly calculating the feature amount and the assessment value based on the various parameters searched, and
determining an effective feature amount high in assessment value meeting set search finish conditions and the various parameters of the effective feature amount at the same time.

9. A parameter search method according to claim 8,
wherein two types of methods are prepared for searching the various parameters including a first method in which a degree of ability to separate the normality and abnormality from each other is emphasized and a second method in which a number of the feature amounts that can be separated is emphasized, and the first search method or the second search method thus set is executed thereby to determine either
(1) an effective feature amount that can separate the normality and abnormality from each other most effectively and various parameters for calculating the effective feature amount, or
(2) a plurality of effective feature amounts for separating the normality and abnormality from each other and various parameters for calculating the effective feature amounts.

10. A program product for determining an effective feature amount suitable for an object of inspection in an inspection/diagnosis apparatus for determining whether the object of inspection is normal or abnormal based on feature amount data obtained by subjecting acquired measurement data to a filtering process and a feature amount extraction process, the program product having a program portion comprising the steps of:
calculating a plurality of feature amounts based on various parameters set by a feature amount calculation unit from a given sample data including the normal data and the abnormal data,
calculating an assessment value indicating an excellence of the various parameters from a result of calculation of the feature amount determined by the feature amount calculation unit,
searching the various parameters again based on the calculated assessment result,
repeating the feature amount calculation and the assessment value calculation based on the various parameters searched until set search finish conditions are met, and determining the effective feature amount high in assessment value meeting the set search finish conditions and the various parameters of the effective feature amount at the same time.

11. A program product according to claim 10,
comprising a program portion for executing selected one of a first method and a second method as a process for searching the various parameters in accordance with the selected search method, the first method being such that a degree of ability to separate the normality and abnormality from each other is emphasized, the second method being such that a number of the separable feature amounts is emphasized.
